(19) United States
(12) Patent Application Publication
(10) Pub. No.: US 2010/0185899 A1
(43) Pub. Date: Jul. 22, 2010

(54) RAID TESTING METHOD AND TESTING SYSTEM

(75) Inventor: Chung-Chiang CHEN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/407,794

(22) Filed: Mar. 20, 2009

(30) Foreign Application Priority Data
Jan. 16, 2009 (TW) 98101675

(51) Int. Cl. G06F 11/16; G06F 12/00; G06F 11/00

(52) U.S. Cl. 714/42; 711/114; 714/E11.062; 711/E12.001; 711/E12.084

(57) ABSTRACT

A RAID testing method and a RAID testing system including a reading unit, an option-ROM, a recording unit and several RAID configuration data are provided. These data are either contained in several binary files or stored in a memory. In the method, first, these data are read by the reading unit under a first mode to simulate connecting to several physical disk drives in a first manner. Then, a global RAID configuration information is generated according to these RAID configuration data. Further, these data are read by the reading unit under a second mode to simulate connecting to these physical disk drives in a second manner. Afterwards the global RAID configuration information is updated by the option-ROM in accordance with the second mode. Moreover, the global RAID configuration information is recorded by the recording unit.

### RELATED APPLICATIONS

This application claims priority to Taiwan Application Serial Number 98101675, filed Jan. 16, 2009, which is herein incorporated by reference.

### BACKGROUND

1. Field of Invention

The present invention relates to a RAID testing method and a testing system. More particularly, the present invention relates to a RAID testing method and a testing system having improved testing efficiency.

2. Description of Related Art

Generally, when a RAID test is conducted, the following steps are performed. First, numerous physical disk drives are connected in the RAID system, and then the RAID system is built and configured by RAID configuration tools such as HP brand ORCA and ACU modules. Next, the actual pulling and plugging actions of the physical disk drives must be performed so as to carry out various test items on the RAID system. For example, in a RAID error handling test of a RAID1 logical disk built from two physical disk drives, one of the physical disk drives is pulled out from the RAID system, and then the status of the RAID system and the procedure that the option-ROM should be commencing after pulling out the physical disk drive are examined. During the test, test personnel have to actually disconnect the flat cable, or even remove the physical hard disk drive from the disk slot. On the other hand, each test result must be individually outputted by the output module, and test personnel must spend time waiting for the output module. After one of the test items is finished, the test result must be manually observed from the testing machine. Consequently, the RAID test can not carry on to the next test item until the test result is observed manually.

When several different test items are to be tested, test personnel must repeatedly pull and plug the physical disk drives and must stand by the test machine to wait for the test results. Therefore, intensive manual labor and a period of waiting time are required, making it impossible to conduct the RAID test quickly and effectively. Moreover, numerous physical disk drives are connected in the RAID system during testing, so the hardware cost is raised.

### SUMMARY

The present invention is directed to a RAID testing method and a RAID testing system. During RAID testing there is no need to pull and plug physical disk drives, so the testing efficiency and testing convenience can be improved.

According to an aspect of the invention, a RAID testing method is provided. The method includes the following steps. First, several RAID configuration data are read under a first mode to simulate connecting to several physical disk drives in a first manner. Then, a global RAID configuration information is generated according to the RAID configuration data. Further, the RAID configuration data are read under a second mode to simulate connecting to these physical disk drives in a second manner. Afterwards, the global RAID configuration information is updated in accordance with the second mode. Moreover, the global RAID configuration information is recorded.

According to another aspect of the invention, a RAID testing system is provided. The system includes several binary files, a reading unit, an option-ROM and a recording unit. Each binary file contains one of several RAID configuration data. The reading unit is used for reading these binary files under several modes. The option-ROM is used for generating a global RAID configuration information according to the RAID configuration data in these binary files. The option-ROM is also used for updating the global RAID configuration information in accordance with these modes. The recording unit is used for recording the global RAID configuration information.

According to a further aspect of the invention, another RAID testing system is provided. The system includes a memory, a reading unit, an option-ROM and a recording unit. Several RAID configuration data are stored in the memory. The reading unit is used for reading the RAID configuration data from the memory under several modes. The option-ROM is used for generating a global RAID configuration information according the read RAID configuration data. The option-ROM is also used for updating the global RAID configuration in accordance with these modes. The recording unit is used for recording the global RAID configuration information.

In the present invention, the connection with these physical disk drives is simulated by reading the RAID configuration data. Different RAID test items can be conducted by changing the mode under which these RAID configuration data are read. Therefore, the action of pulling and plugging these physical disk drives can be omitted, improving the test efficiency and convenience. In addition, the test results can be promptly examined by way of recording the global RAID configuration information, and the time of waiting for the output module is saved.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a function diagram of a RAID testing system according to an embodiment of the invention;

FIG. 2 is a flow chart of a RAID testing method according to an embodiment of the invention; and

FIG. 3 is a function diagram of a RAID testing system according to another embodiment of the invention.

### DETAILED DESCRIPTION

Reference will now be made in detail to the present embodiments of the invention, examples of which are illustrated in the accompanying drawings.

In the Redundant Array of Independent Disks (RAID) testing method and testing system according to the embodiments of the present invention, the states of connecting to several physical disk drives are simulated by connecting and accessing several RAID configuration data by the option-ROM. During testing, all that needs to be done to simulate the manners of connecting these physical disk drives is to change the modes under which these RAID configuration data are read. Therefore, the actual pulling and plugging actions of these physical disk drives are omitted, and the test efficiency and convenience can be improved.

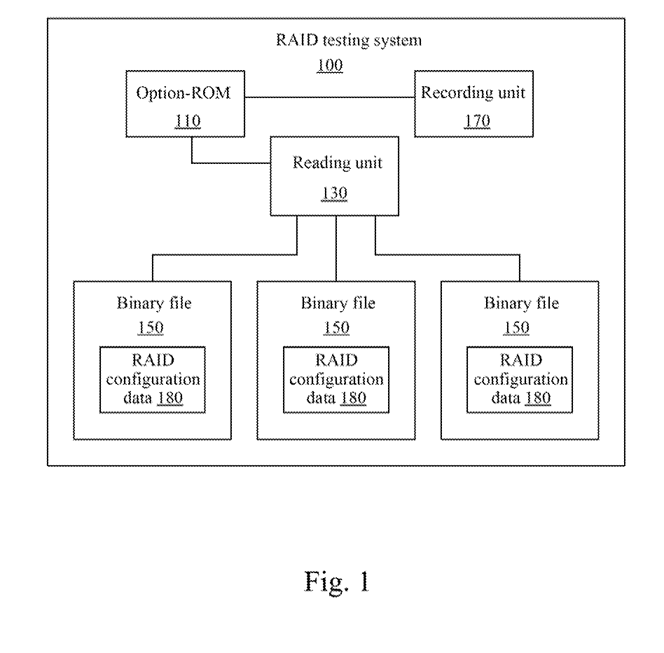

Please refer to FIG. 1, a function diagram of a RAID testing system according to an embodiment of the invention is shown. The RAID testing system 100 includes several binary files 150, a reading unit 130, an option-ROM 110 and a recording unit 170. Each of the binary files 150 contains one of several RAID configuration data 180. The reading unit 130 is used for reading the binary files 150 under several modes to acquire the RAID configuration data 180 contained in the binary files 150. The option-ROM 110 is used for generating a global RAID configuration information according to the RAID configuration data 180 in the binary files 150. The option-ROM 110 is also used for updating the global RAID configuration information in accordance with these modes. The recording unit 170 is used for recording the global RAID configuration information. By reading the RAID configuration data 180 in the binary files 150, test personnel need not pull and plug these physical disk drives repeatedly. In addition, test personnel can get the test results from the recorded global RAID configuration information promptly. Therefore, the test convenience and efficiency can be improved.

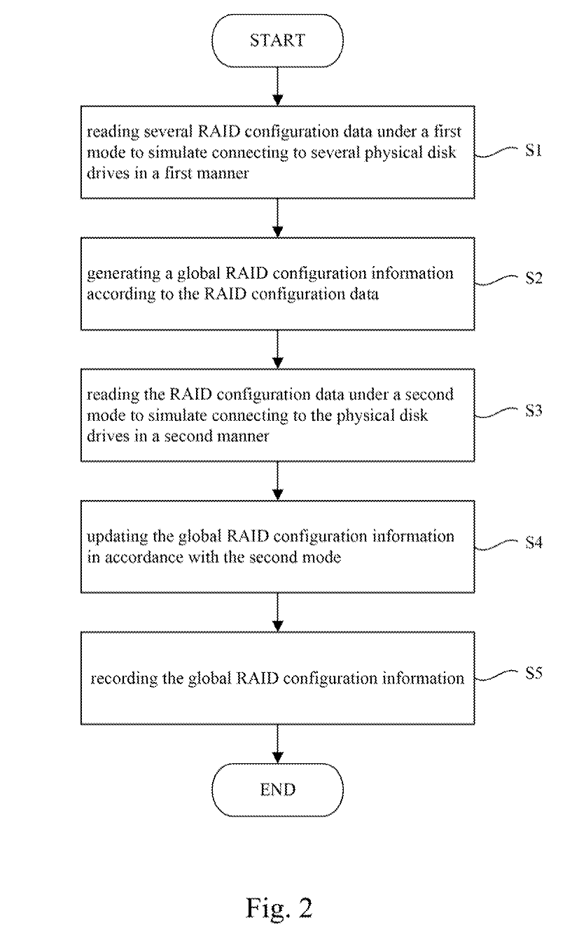

The testing system 100 of the embodiment adopts a RAID testing method according to an embodiment of the invention. Referring to FIG. 2, a flow chart of the RAID testing method according to an embodiment of the invention is shown. First, as shown in step S1, several RAID configuration data 180 are read under a first mode to simulate connecting to several physical disk drives in a first manner. The test method of the present embodiment further includes a step of providing these binary files 150. Each binary file 150 contains one of the RAID configuration data 180. In this step, all binary files 150 are read by the reading unit 130 under the first mode, so that all RAID configuration data 180 are connected and accessible to the option-ROM 110. When all RAID configuration data 180 are connected and accessible to the option-ROM 110, the testing system 100 simulates that all the physical disk drives are connected to the option-ROM 110. Therefore, the testing system 100 can be regarded as connecting to one of the physical disk drives when one of the RAID configuration data 180 is connected and accessible to the option-ROM 110.

Then the method moves to step S2, generating the global RAID configuration information according to these RAID configuration data 180. In the testing system 100, the global RAID configuration information is generated by the option-ROM 110 by way of gathering and integrating these RAID configuration data 180.

Further, the method of the present embodiment moves to step S3. The RAID configuration data 180 are read under a second mode to simulate connecting to these physical disk drives in a second manner. Exemplarily, only a part of the RAID configuration data 180 is connected and accessible under the second mode of the present embodiment. In the testing system 100, only a part of the binary files 150 is read by the reading unit 130 under the second mode, so that only a part of the RAID configuration data 180 is connected and accessible to the option-ROM 110. Practically, when a part of the RAID configuration data 180 is connected and accessible to the option-ROM 110, the testing system 100 simulates that the option-ROM 110 only connects to a part of the physical disk drives. In the present embodiment, the testing system 100 simulates pulling out a part of the physical disk drives by reducing the number of read binary files 150, so there is no need to actually pull out the physical disk drives. Therefore, the cost of using physical disk drives is saved, the testing steps are simplified, and the test efficiency is improved.

Afterwards, a step of updating the global RAID configuration information in accordance with the second mode is performed as shown in step S4. In the testing system 100, when the status that the option-ROM 110 connects to and accesses the RAID configuration data 180 is altered, such as reducing the number of the RAID configuration data 180 that are connected and accessible to the option-ROM 110 to simulate a part of the physical disk drives being pulled out, the option-ROM 110 updates the present global RAID configuration information thereupon.

Next, a step of recording the global configuration information is performed in the testing method of the present embodiment, as shown in step S5. Practically, the testing system 100 records pre-updating and post-updating global RAID configuration information by the recording unit 170. Test personnel can learn the configurations of the RAID system before and after changing the mode of reading the RAID configuration data 180 by examining the recorded global RAID configuration information. The test result can be promptly examined and the time of waiting for the output module can be saved.

The testing method of the present embodiment further includes a step of reading the RAID configuration data 180 under a third mode, so as to simulate connecting to the physical disk drives in a third manner. Exemplarily, the third mode is the same as the first mode in the present embodiment. In other words, all the RAID configuration data 180 are connected and accessible to the option-ROM 110 under the third mode. Therefore, the testing system 100 simulates the status that all the physical disk drives are reconnected to the option-ROM 110. And then, the option-ROM 110 updates the global RAID configuration information in accordance with the third mode, and the recording unit 170 records the updated global RAID configuration information. In the embodiment of the present invention, the recording unit 170 repeats the step of recording global RAID configuration information for several times to record numerous pre-updating and post-updating global RAID configuration information, thereby forming a list. Because there is no need to perform the time-consuming and labor-intensive actions of pulling and plugging the physical disk drives, the testing system 100 can conduct the RAID test quickly and successively. In addition, the global RAID configuration information after finishing several test items are gathered and integrated into the list, so test personnel can examine multiple test results at the same time.

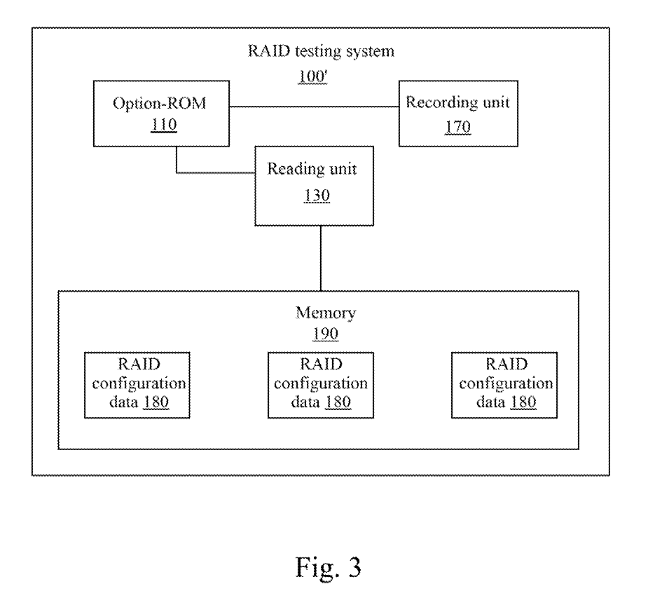

Exemplarily, the number of the connected and accessible RAID configuration data 180 is decreased and then restored under the second mode and the third mode respectively, so that the situations of pulling out and connecting back a part of the physical disk drives can be simulated. However, the technology of the embodiment of the invention is not limited thereto; any technique that simulates different manners of connecting physical disk drives by changing the reading modes is covered by the scope of the invention. On the other hand, practically, the RAID testing method of the embodiment can be adaptable to an operating system for the reason that the RAID configuration data 180 are contained in the binary files 150 and the RAID test is carried out by reading the binary files 150 in the operating system. In another embodiment, the RAID configuration data 180 are stored in a memory. Please refer to FIG. 3, a function diagram of a RAID testing system according to another embodiment of the invention is shown. The RAID configuration data 180 are stored in the memory 190, and the RAID testing method can be adaptable to a firmware environment before starting the operating system.

The RAID configuration data 180 can be acquired from the physical disk drives in a RAID system waiting to be tested. The data segments of the RAID configuration information can be learned by analyzing the reserved information sectors (RIS) of each hard disk in the RAID system waiting to be tested, thereby producing corresponding RAID configuration data 180. As a result, the RAID testing method and the RAID testing system 100 of the present embodiment can be adaptable to different types and brands of RAID systems by producing corresponding RAID configuration data 180, thus greatly increasing the applicability.

According to the above-described RAID testing method and the RAID testing system of the embodiments of the present invention, the status of connecting to several physical disk drives is simulated by connecting and accessing the RAID configuration data that are equal to the ones stored in the physical disk drives. The test is carried out simply by changing the mode of reading the RAID configuration data without actually pulling and plugging these physical disk drives. The convenience of RAID test is improved, and the hardware and labor costs of RAID test with numerous physical disk drives are saved. Further, corresponding RAID configuration data can be produced by analyzing the configuration information in physical disk drives, so the RAID testing method and the RAID testing system can be adaptable to different types and brands of RAID systems. The applicability is greatly increased. Moreover, batch test items can be successively performed by recording numbers of global RAID configuration information at the same time, and test personnel can examine multiple test results simultaneously. Therefore, the test efficiency is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A RAID testing method, comprising:
reading a plurality of RAID configuration data under a first mode to simulate connecting to a plurality of physical disk drives in a first manner;
generating a global RAID configuration information according to the RAID configuration data;
reading the RAID configuration data under a second mode to simulate connecting to the physical disk drives in a second manner,
updating the global RAID configuration information in accordance with the second mode; and
recording the global RAID configuration information.

2. The RAID testing method of claim 1, further comprising:
providing a plurality of binary files, wherein each binary file contains one of the RAID configuration data.

3. The RAID testing method of claim 1, wherein the RAID configuration data are stored in a memory.

4. The RAID testing method of claim 1, wherein an option-ROM connects to and accesses all the RAID configuration data under the first mode.

5. The RAID testing method of claim 4, wherein the option-ROM connects to and accesses a part of the RAID configuration data under the second mode.

6. The RAID testing method of claim 1, further comprising:
reading the RAID configuration data under a third mode to simulate connecting to the physical disk drives in a third manner.

7. The RAID testing method of claim 6, wherein the third mode is the same as the first mode, and the third manner is equal to the first manner.

8. The RAID testing method of claim 6, further comprising:
updating the global RAID configuration information in accordance with the third mode.

9. The RAID testing method of claim 8, wherein the step of recording the global RAID configuration information is repeated a plurality of times to record a plurality of pre-updating and post-updating global RAID configuration information.

10. A RAID testing system, comprising:
a plurality of binary files, each binary file containing one of a plurality of RAID configuration data;
a reading unit for reading the binary files under a plurality of modes;
an option-ROM for generating a global RAID configuration information according to the RAID configuration data in the binary files and for updating the global RAID configuration information in accordance with the modes; and
a recording unit for recording the global RAID configuration information.

11. The RAID testing system of claim 10, wherein the modes comprise a first mode and a second mode, all the RAID configuration data are connected and accessible to the option-ROM under the first mode, and a part of the RAID configuration data is connected and accessible to the option-ROM under the second mode.

12. The RAID testing system of claim 11, wherein the modes further comprise a third mode that is the same as the first mode.

13. The RAID testing system of claim 10, wherein the recording unit is used for recording a plurality of pre-updating and post-updating global RAID configuration information.

14. A RAID testing system, comprising:
a memory storing a plurality of RAID configuration data;
a reading unit for reading the RAID configuration data from the memory under a plurality of modes;
an option-ROM for generating a global RAID configuration information according to the read RAID configuration data and for updating the global RAID configuration information in accordance with the modes; and
a recording unit for recording the global RAID configuration information.

15. The RAID testing system of claim 14, wherein the modes comprise a first mode and a second mode, all the RAID configuration data are connected and accessible to the option-ROM under the first mode, and a part of the RAID configuration data is connected and accessible to the option-ROM under the second mode.

16. The RAID testing system of claim 15, wherein the modes further comprise a third mode that is the same as the first mode.

17. The RAID testing system of claim 14, wherein the recording unit is used for recording a plurality of pre-updating and post-updating global RAID configuration information.
